(19) United States
(12) Patent Application Publication
(10) Pub. No.: US 2013/0153187 A1
(43) Pub. Date: Jun. 20, 2013

(54) Dual Heat Sinks For Distributing A Thermal Load

(71) Applicants: Zachary B. Durham, Durham, NC (US); William M. Megarity, Roxboro, NC (US)

(72) Inventors: Zachary B. Durham, Durham, NC (US); William M. Megarity, Roxboro, NC (US)

(73) Assignee: INTERNATIONAL BUSINESS MACHINES CORPORATION, Armonk, NY (US)

(21) Appl. No.: 13/325,862

(22) Filed: Dec. 14, 2011

(51) Int. Cl. F28F 7/00; B23P 19/00

(52) U.S. Cl. 165/185; 29/428

(57) ABSTRACT

Dual heat sinks, apparatuses, and methods for installing a dual heat sink for distributing a thermal load are provided. Embodiments include a top base to couple with a first integrated circuit of a first board and to receive a first thermal load from the first integrated circuit; a bottom base to couple with a second integrated circuit of a second board and to receive a second thermal load from the second integrated circuit; and a thermal dissipating structure coupled between the top base and the bottom base, the thermal dissipating structure to receive and distribute the first thermal load and the second thermal load from the top base and the bottom base; wherein a height of the thermal dissipating structure is adjustable so as to change a distance separating the top base and the bottom base.

### BACKGROUND OF THE INVENTION

1. Field of the Invention

The field of the invention is data processing, or, more specifically, dual heat sinks, apparatuses, and methods for installing a dual heat sink for distributing a thermal load.

2. Description of Related Art

The development of the EDVAC computer system of 1948 is often cited as the beginning of the computer era. Since that time, users have relied on computer systems to simplify the process of information management. Today's computer systems are much more sophisticated than early systems such as the EDVAC. Such modern computer systems deliver powerful computing resources to provide a wide range of information management capabilities through the use of computer software such as database management systems, word processors, spreadsheets, client/server applications, web services, and so on.

In order to deliver powerful computing resources, computer system designers must design powerful computer processors. Current computer processors, for example, are capable of executing billions of computer program instructions per second. Operating these computer processors requires a significant amount of power, and often such processors can consume over 100 watts. Consuming significant amounts of power generates a considerable amount of heat. Unless the heat is removed, heat generated by a computer processor may degrade or destroy the processor's functionality.

To prevent the degradation or destruction of a computer processor, a computer architect may remove heat from the processor by using heat sinks. In general, the ability of a heat sink to remove heat is directly proportional to the size of the heat sink. However, in a server chassis that includes multiple boards with multiple integrated circuits, each of which is cooled by a heat sink, space is limited.

### SUMMARY OF THE INVENTION

Dual heat sinks, apparatuses, and methods for installing dual heat sinks for distributing a thermal load are provided. Embodiments include a top base to couple with a first integrated circuit of a first board and to receive a first thermal load from the first integrated circuit; a bottom base to couple with a second integrated circuit of a second board and to receive a second thermal load from the second integrated circuit; and a thermal dissipating structure coupled between the top base and the bottom base, the thermal dissipating structure to receive and distribute the first thermal load and the second thermal load from the top base and the bottom base; wherein a height of the thermal dissipating structure is adjustable so as to change a distance separating the top base and the bottom base.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth an exemplary apparatus for distributing a thermal load according to embodiments of the present invention.

FIG. 2 sets forth another example of an apparatus for distributing a thermal load according to embodiments of the present invention.

FIG. 3 sets forth another example of an apparatus for distributing a thermal load according to embodiments of the present invention.

FIG. 4 sets forth another example of an apparatus for distributing a thermal load according to embodiments of the present invention.

FIG. 5 sets forth a flow chart illustrating an exemplary method for installing a dual heat sink for distributing a thermal load according to embodiments of the present invention.

FIG. 6 sets forth a flow chart illustrating a further exemplary method for installing a dual heat sink for distributing a thermal load according to embodiments of the present invention.

### DETAILED DESCRIPTION OF EXEMPLARY EMBODIMENTS

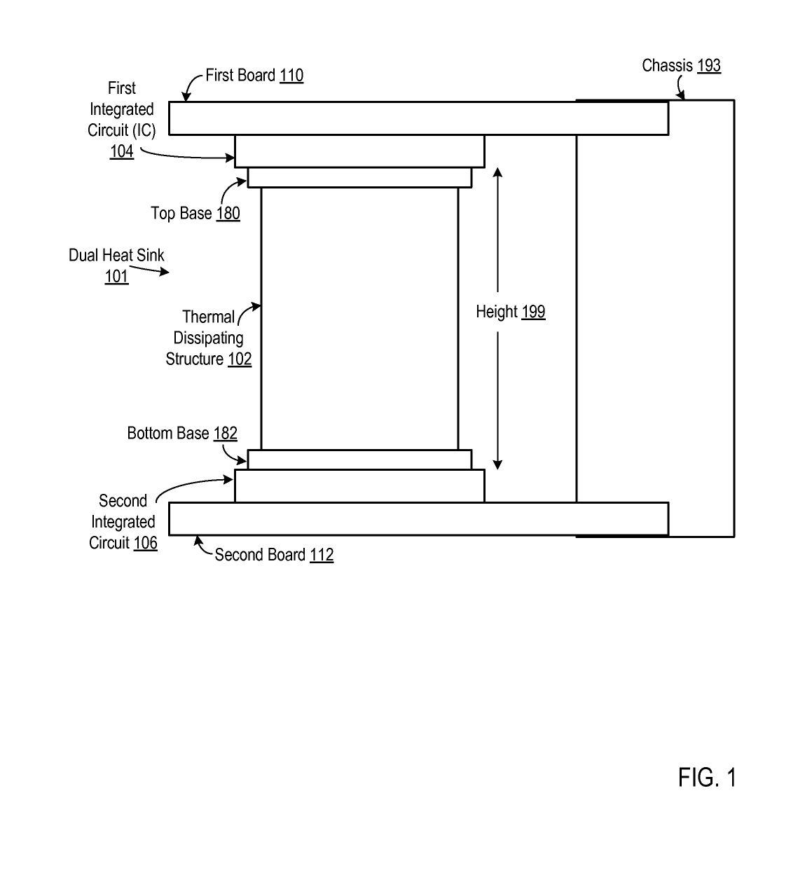

Exemplary dual heat sinks, apparatuses, and methods for installing a dual heat sink for distributing a thermal load in accordance with the present invention are described with reference to the accompanying drawings, beginning with FIG. 1. FIG. 1 sets forth an exemplary apparatus for distributing a thermal load according to embodiments of the present invention. The thermal load is the rate of thermal energy produced over time from the operation of an integrated circuit package such as, for example, a computer processor or memory integrated circuit and is typically expressed in units of Watts.

The apparatus of FIG. 1 includes a first integrated circuit (104) coupled to a first board (110), a second integrated circuit (106) coupled to a second board (112), and a chassis (193). In the example of FIG. 1, the first board (110) is fastened to the top of the chassis (193) and the second board (112) is fastened to the bottom of the chassis (193). During operation, the first integrated circuit (104) generates a first thermal load and the second integrated circuit (106) generates a second thermal load.

The apparatus of FIG. 1 also includes a dual heat sink (101) coupled between the first integrated circuit (104) and the second integrated circuit (106). A heat sink may be coupled to an integrated circuit by a thermal interface. A thermal interface is a thermally conductive material that reduces thermal resistance associated with transferring a thermal load from an integrated circuit to the heat sink. A thermal interface between an integrated circuit package and a heat sink has less thermal resistance than could typically be produced by connecting the integrated circuit directly to the heat sink. Decreasing the thermal resistance between the integrated circuit and the heat sink increases the efficiency of transferring the thermal load from the integrated circuit to the heat sink. Examples of thermal interfaces include non-adhesive materials such as, for example, thermal greases, phase change materials, and gap-filling pads. A thermal interface may also include adhesive materials such as, for example, thermosetting liquids, pressure-sensitive adhesive (‘PSA’) tapes, and thermoplastic or thermosetting bonding films.

A heat sink is a thermal conductor that is configured to absorb and dissipate thermal loads from integrated circuits thermally connected with the heat sink. Thermal conductors used in designing heat sinks may include, for example, aluminum, copper, silver, aluminum silicon carbide, or carbon-based composites. When thermally connecting a heat sink to an integrated circuit, the heat sink provides additional thermal mass, cooler than the integrated circuit, into which a thermal load may flow. After absorbing the thermal load, the heat sink dissipates the thermal load through thermal convection and thermal radiation into the air surrounding the heat sink. Increasing the surface area of the heat sink typically increases the rate of dissipating the thermal load.

The dual heat sink (101) of FIG. 1 is a “dual” heat sink because the heat sink is shared by multiple integrated circuits. That is, the first integrated circuit (104) and the second integrated circuit (106) share the same dual heat sink (101).

In the example of FIG. 1, the dual heat sink (101) includes a top base (180), a bottom base (182) and a thermal dissipating structure (102). The top base (180) is configured to couple with the first integrated circuit (104) of the first board (110) and to receive a first thermal load from the first integrated circuit (104). The bottom base (182) is configured to couple with the second integrated circuit (106) of the second board (112) and to receive a second thermal load from the second integrated circuit (106).

In the example of FIG. 1, the thermal dissipating structure (102) is coupled between the top base (180) and the bottom base (182). The thermal dissipating structure (102) is configured to receive and distribute the first thermal load and the second thermal load from the top base (180) and the bottom base (182). The thermal dissipating structure (102) is configured to be adjustable. In the example of FIG. 1, a height (199) of the thermal dissipating structure (102) is adjustable so as to change a distance separating the top base (180) and the bottom base (182).

A height adjustable dual heat sink enables the same heat sink to be used for a variety of integrated circuit configurations. For example, in a first configuration, both the first integrated circuit (104) and the second integrated circuit (106) may each be made by a first manufacturer and have a first thickness, while in a second configuration, the first integrated circuit (104) and the second integrated circuit (106) may each be made by a second manufacturer and have a second thickness. If in both configurations, the boards attached to the integrated circuits are fastened to the chassis in locations that are the same distance apart, then the distance between the integrated circuits would vary between the two configurations. Because the height of a dual heat sink is adjustable, the same dual heat sink may be used in both configurations by either increasing or decreasing the height of the dual heat sink.

In addition to the benefit that a height adjustable dual heat sink enables multiple integrated circuit configurations, a height adjustable dual heat sink also enables the dual heat sink to be installed after the boards are inserted into the chassis. For example, a height of the dual heat sink may be reduced so as align the dual heat sink between the integrated circuits at which point, the height of the dual heat sink may be increased until the top base and the bottom base of the dual heat sink are in contact with the integrated circuits. That is, a height adjustable dual heat sink in accordance with embodiments of the present invention enables the same dual heat sink to be installed in a variety of configuration with or without removing boards from a chassis, thus providing multiple benefits to a system administrator servicing a chassis.

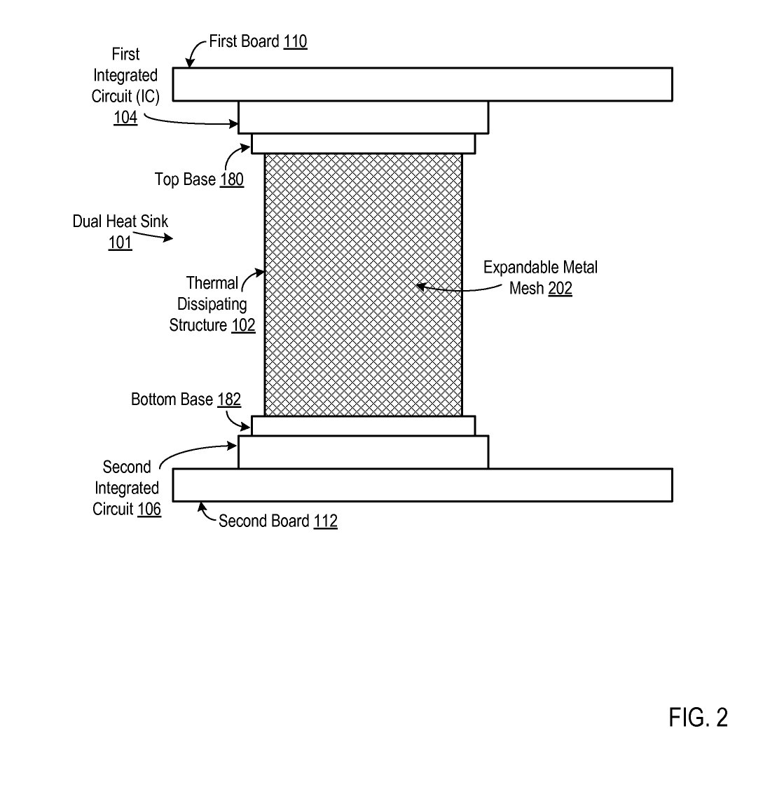

FIG. 2 sets forth another example of an apparatus for distributing a thermal load according to embodiments of the present invention. The apparatus of FIG. 2 is similar to the apparatus of FIG. 1 in that the apparatus of FIG. 2 also includes the first integrated circuit (104) coupled to the first board (110), the second integrated circuit (106) coupled to the second board (112), and the dual heat sink (101) that includes the top base (180), the bottom base (182), and the thermal dissipating structure (102).

In the example of FIG. 2, however, the thermal dissipating structure (102) includes an expandable metal mesh (202) coupled between the top base (180) and the bottom base (182). The expandable metal mesh (202) is capable of compressing and uncompressing. To uncompress the expandable metal mesh (202), force may be applied that pulls the top plate (180) and the bottom plate (182) further together. Conversely, the expandable metal mesh (202) applies a force that decreases the distance separating the top base (180) and the bottom base (182). Thus, for both installing and removing the dual heat sink (101) from between the first integrated circuit (104) and the second integrated circuit (106), the height of the thermal dissipating structure (102) may be reduced by compressing the expandable metal mesh (202). Conversely, for securing the dual heat sink (101) between the first integrated circuit (104) and the second integrated circuit (106), the height of the thermal dissipating structure (102) may be increased by uncompressing the expandable metal mesh (202).

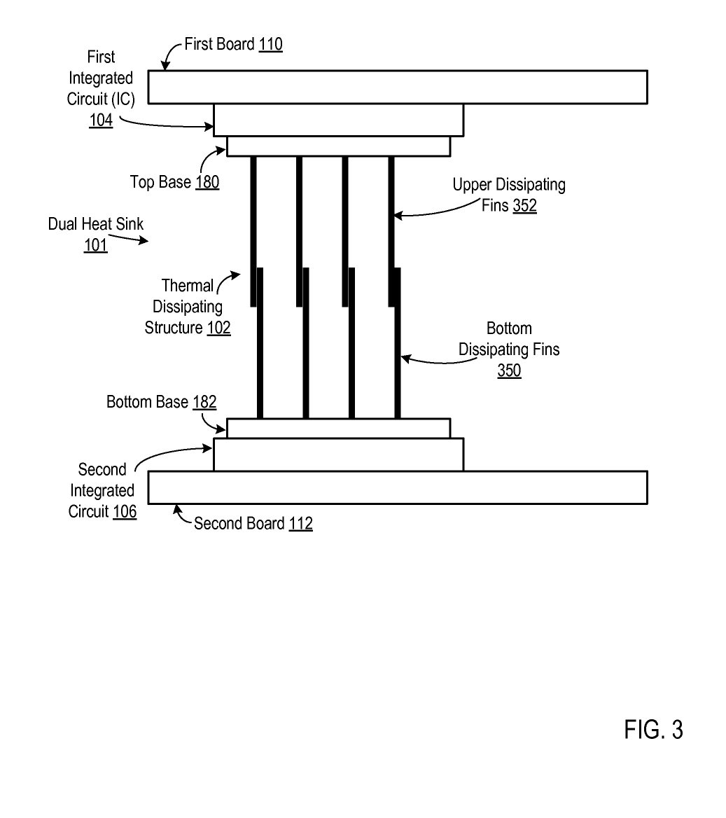

FIG. 3 sets forth another example of an apparatus for distributing a thermal load according to embodiments of the present invention. The apparatus of FIG. 3 is similar to the apparatus of FIG. 1 in that the apparatus of FIG. 3 also includes the first integrated circuit (104) coupled to the first board (110), the second integrated circuit (106) coupled to the second board (112), and the dual heat sink (101) that includes the top base (180), the bottom base (182), and the thermal dissipating structure (102).

In the example of FIG. 3, however, the thermal dissipating structure (102) includes upper dissipating fins (352) coupled to the top base (180) and bottom dissipating fins (350) coupled to the bottom base (182). A dissipating fin is a thermal conductor that provides additional surface area for dissipating a thermal load. The dissipating fins (350, 352) of FIG. 3 are spaced apart in parallel and extend from either the top base (180) or the bottom base (182). The dissipating fins (350, 352) may be connected to the top base (180) or the bottom base (182) by bonding the dissipating fins to a base through the use of epoxy, press-fit, brazing, welding, or other connections as may occur to those of skill in the art. In the example of FIG. 3, each bottom dissipating fin is in contact with a single upper dissipating fin and is separated apart in parallel from another upper dissipating fin. The contact between the upper dissipating fins and the bottom dissipating fins enables thermal conduction between the two sets of fins. That is, the thermal load from the upper dissipating fins (352) may be transferred to the bottom dissipating fins (350) and vice versa. However, the space between the two sets of fins enables each fin to dissipate a received thermal load. In a particular embodiment, a thermal interface material may be applied between each bottom dissipating fin and upper dissipating fin that are in contact.

As explained above, the height of the dual heat sink (101) is adjustable. In the example of FIG. 3, the height of the dual heat sink (101) is adjusted by sliding the bottom dissipating fins (350) relative to the upper dissipating fins (352) to either increase or decrease separation between the top base (180) and the bottom base (182). The height of the dual heat sink (101) may be set by fastening the top base (180) to one of the first integrated circuit (104) and the first board (110) and by fastening the bottom base (182) to one of the second integrated circuit (106) and the second board (112).

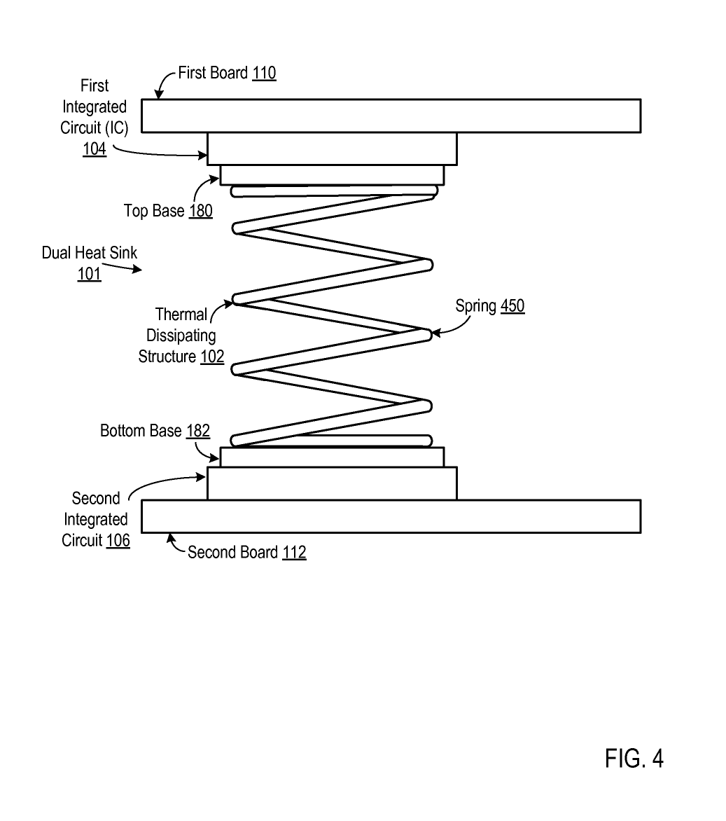

FIG. 4 sets forth another example of an apparatus for distributing a thermal load according to embodiments of the present invention. The apparatus of FIG. 4 is similar to the apparatus of FIG. 1 in that the apparatus of FIG. 4 also includes the first integrated circuit (104) coupled to the first board (110), the second integrated circuit (106) coupled to the second board (112), and the dual heat sink (101) that includes the top base (180), the bottom base (182), and the thermal dissipating structure (102).

In the example of FIG. 4, however, the thermal dissipating structure (102) includes a spring (450) coupled between the top base (180) and the bottom base (182). The spring (450) is capable of compressing and uncompressing. To compress the spring (450), force may be applied that presses the top plate (180) and the bottom plate (182) closer together. As the spring (450) uncompresses, the spring (450) applies a force that increases the distance separating the top base (180) and the bottom base (182). Thus, for both installing and removing the dual heat sink (101) from between the first integrated circuit (104) and the second integrated circuit (106), the height of the thermal dissipating structure (102) may be reduced by compressing the spring (450). Conversely, for securing the dual heat sink (101) between the first integrated circuit (104) and the second integrated circuit (106), the height of the thermal dissipating structure (102) may be increased by uncompressing the spring (450). In a particular embodiment, the spring (450) acts to dissipate the first thermal load and the second thermal load.

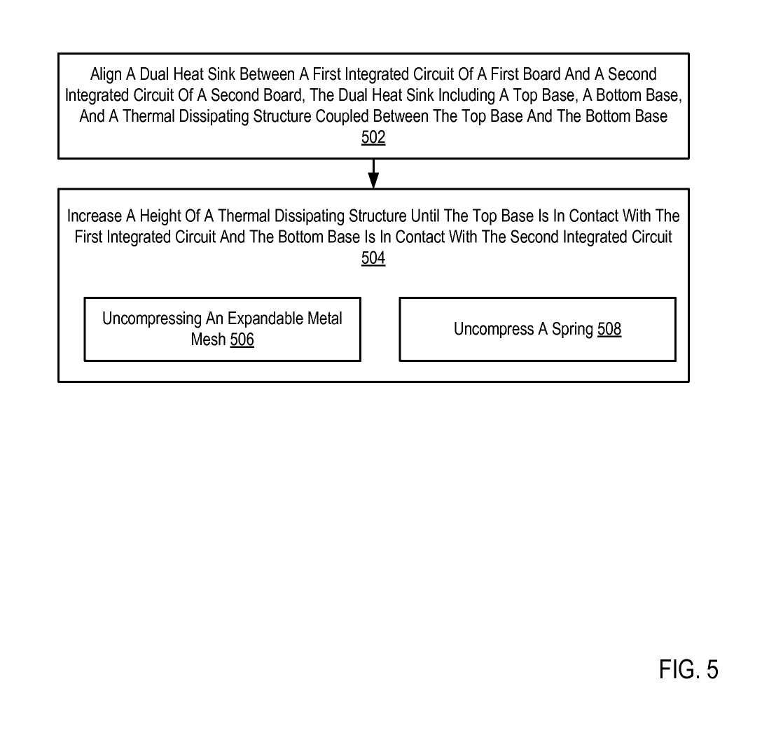

For further explanation, FIG. 5 sets forth a flow chart illustrating an exemplary method for installing a dual heat sink for distributing a thermal load according to embodiments of the present invention. For ease of reference, the components of the apparatuses of FIGS. 1-4 are referenced in the description of a method for installing a dual heat sink.

The method of FIG. 5 includes aligning (502) a dual heat sink (101) between a first integrated circuit (104) of a first board (110) and a second integrated circuit (106) of a second board (112). Aligning (502) a dual heat sink (101) between a first integrated circuit (104) of a first board (110) and a second integrated circuit (106) of a second board (112) may be carried out by positioning the dual heat sink (101) between the first integrated circuit (104) and the second integrated circuit (106).

The method of FIG. 5 also includes increasing (504) a height of the thermal dissipating structure (102) until the top base (180) is in contact with the first integrated circuit (104) and the bottom base (182) is in contact with the second integrated circuit (106). Increasing (504) a height of the thermal dissipating structure (102) until the top base (180) is in contact with the first integrated circuit (104) and the bottom base (182) is in contact with the second integrated circuit (106) may be carried out by uncompressing (506) an expandable metal mesh (202); or uncompressing (408) a spring (450) within the thermal dissipating structure (102).

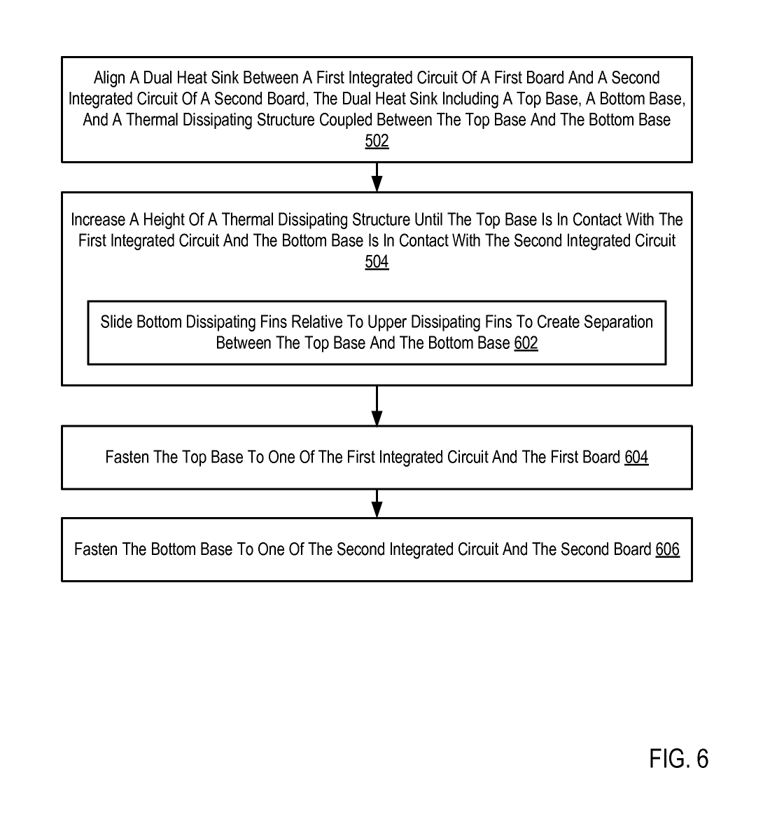

For further explanation, FIG. 6 sets forth a flow chart illustrating a further exemplary method for installing dual heat sinks for distributing a thermal load according to embodiments of the present invention. The method of FIG. 6 is similar to the method of FIG. 5 in that the method of FIG. 6 also includes aligning (502) a dual heat sink (101) between a first integrated circuit (104) of a first board (110) and a second integrated circuit (106) of a second board (112); and increasing (504) a height of the thermal dissipating structure (102) until the top base (180) is in contact with the first integrated circuit (104) and the bottom base (182) is in contact with the second integrated circuit (106).

In the method of FIG. 6, however, increasing (504) a height of the thermal dissipating structure (102) until the top base (180) is in contact with the first integrated circuit (104) and the bottom base (182) is in contact with the second integrated circuit (106) includes sliding (602) bottom dissipating fins (350) relative to upper dissipating fins (352) to create separation between the top base (180) and the bottom base (182).

The method of FIG. 6 also includes fastening (604) the top base (180) to one of the first integrated circuit (102) and the first board (110). Fastening (604) the top base (180) to one of the first integrated circuit (102) and the first board (110) may be carried out by screwing the top base (180) into one of the first integrated circuit (102) and the first board (110).

The method of FIG. 6 also includes fastening (606) the bottom base (182) to one of the second integrated circuit (106) and the second board (112). Fastening (606) the bottom base (182) to one of the second integrated circuit (106) and the second board (112) may be carried out by screwing the top base (180) into one of the second integrated circuit (106) and the second board (112).

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A dual heat sink for distributing a thermal load, the dual heat sink comprising:
a top base to couple with a first integrated circuit of a first board and to receive a first thermal load from the first integrated circuit;
a bottom base to couple with a second integrated circuit of a second board and to receive a second thermal load from the second integrated circuit; and
a thermal dissipating structure coupled between the top base and the bottom base, the thermal dissipating structure to receive and distribute the first thermal load and the second thermal load from the top base and the bottom base;
wherein a height of the thermal dissipating structure is adjustable so as to change a distance separating the top base and the bottom base.

2. The dual heat sink of claim 1 wherein the thermal dissipating structure includes an expandable metal mesh coupled between the top base and the bottom base, the expandable metal mesh applying a force that decreases the distance separating the top base and the bottom base.

3. The dual heat sink of claim 1 wherein the thermal dissipating structure includes:
upper dissipating fins coupled to the top base; and
bottom dissipating fins coupled to the bottom base; wherein each bottom dissipating fin is in contact with a single upper dissipating fin and is separated apart in parallel from another upper dissipating fin.

4. The dual heat sink of claim 3 including thermal interface material between each bottom dissipating fin and upper dissipating fin that are in contact.

5. The dual heat sink of claim 1 wherein the thermal dissipating structure includes a spring coupled between the top base and the bottom base, the spring applying a force that increases the distance between the top base and the bottom base.

6. The dual heat sink of claim 5 wherein the spring acts to dissipate the first thermal load and the second thermal load.

7. A method for installing a dual heat sink for distributing a thermal load, the method comprising:
aligning a dual heat sink between a first integrated circuit of a first board and a second integrated circuit of a second board; the dual heat sink including:
a top base to couple with the first integrated circuit and to receive a first thermal load from the first integrated circuit;
a bottom base to couple with the second integrated circuit and to receive a second thermal load from the second integrated circuit; and
a thermal dissipating structure coupled between the top base and the bottom base, the thermal dissipating structure to receive and distribute the first thermal load and the second thermal load from the top base and the bottom base;
increasing a height of the thermal dissipating structure until the top base is in contact with the first integrated circuit and the bottom base is in contact with the second integrated circuit.

8. The method of claim 7 wherein the thermal dissipating structure includes an expandable metal mesh coupled between the top base and the bottom base, the expandable metal mesh applying a force that decreases the distance separating the top base and the bottom base; and
wherein increasing a height of the thermal dissipating structure until the top base is in contact with the first integrated circuit and the bottom base is in contact with the second integrated circuit includes uncompressing the expandable metal mesh.

9. The method of claim 7 wherein the thermal dissipating structure includes:
upper dissipating fins coupled to the top base; and
bottom dissipating fins coupled to the bottom base; wherein each bottom dissipating fin is in contact with a single upper dissipating fin and is separated apart in parallel from another upper dissipating fin;
and wherein increasing a height of the thermal dissipating structure until the top base is in contact with the first integrated circuit and the bottom base is in contact with the second integrated circuit includes sliding the bottom dissipating fins relative to the upper dissipating fins to create separation between the top base and the bottom base;
the method further comprising:
fastening the top base to one of the first integrated circuit and the first board; and
fastening the bottom base to one of the second integrated circuit and the second board.

10. The method of claim 9 wherein the dual heat sink includes thermal interface material between each bottom dissipating fin and upper dissipating fin that are in contact.

11. The method of claim 7 wherein the thermal dissipating structure includes a spring coupled between the top base and the bottom base, the spring applying a force that increases the distance between the top base and the bottom base; and wherein increasing a height of the thermal dissipating structure until the top base is in contact with the first integrated circuit and the bottom base is in contact with the second integrated circuit includes uncompressing the spring.

12. The method of claim 11 wherein the spring acts to dissipate the first thermal load and the second thermal load.

13. An apparatus for distributing a thermal load, the apparatus comprising:
a first integrated circuit coupled to a first board;
a second integrated circuit coupled to a second board;
a dual heat sink coupled between the first integrated circuit and the second integrated circuit; the dual heat sink comprising:
a top base to couple with the first integrated circuit and to receive a first thermal load from the first integrated circuit;
a bottom base to couple with the second integrated circuit and to receive a second thermal load from the second integrated circuit; and
a thermal dissipating structure coupled between the top base and the bottom base, the thermal dissipating structure to receive and distribute the first thermal load and the second thermal load from the top base and the bottom base;
wherein a height of the thermal dissipating structure is adjustable so as to change a distance separating the top base and the bottom base.

14. The apparatus of claim 13 wherein the thermal dissipating structure includes an expandable metal mesh coupled between the top base and the bottom base, the expandable metal mesh applying a force that decreases the distance separating the top base and the bottom base.

15. The apparatus of claim 13 wherein the thermal dissipating structure includes:
upper dissipating fins coupled to the top base; and
bottom dissipating fins coupled to the bottom base; wherein each bottom dissipating fin is in contact with a single upper dissipating fin and is separated apart in parallel from another upper dissipating fin.

16. The apparatus of claim 15 including thermal interface material between each bottom dissipating fin and upper dissipating fin that are in contact.

17. The apparatus of claim 13 wherein the thermal dissipating structure includes a spring coupled between the top base and the bottom base, the spring applying a force that increases the distance between the top base and the bottom base.

18. The apparatus of claim 17 wherein the spring acts to dissipate the first thermal load and the second thermal load.
